(19) United States
(12) Patent Application Publication
(10) Pub. No.: US 2026/0046957 A1
(43) Pub. Date: Feb. 12, 2026

(54) COMMUNICATION APPARATUS, CONTROL METHOD, AND COMPUTER-READABLE STORAGE MEDIUM

(71) Applicant: CANON KABUSHIKI KAISHA, Tokyo (JP)

(72) Inventor: TETSUYA SAWADA, Kanagawa (JP)

(21) Appl. No.: 19/362,577

(22) Filed: Oct. 20, 2025

Related U.S. Application Data
(63) Continuation of application No. PCT/JP2024/013705, filed on Apr. 3, 2024.

(30) Foreign Application Priority Data
Apr. 26, 2023 (JP) 2023-072670

(51) Int. Cl. H04W 76/14; H04W 48/08; H04W 76/10

(52) U.S. Cl. CPC H04W 76/14; H04W 48/08; H04W 76/10

(57) ABSTRACT

A communication apparatus, provides, to another apparatus, setting information including a connection parameter to be used to establish a connection to a first network for enabling the other apparatus to communicate with the communication apparatus, and identification information for specifying a service provided by the communication apparatus, to be used by a service detection method after the establishment of the connection.

### CROSS-REFERENCE TO RELATED APPLICATIONS

This application is a Continuation of International Patent Application No. PCT/JP2024/013705, filed Apr. 3, 2024, which claims the benefit of Japanese Patent Application No. 2023-072670, filed Apr. 26, 2023, both of which are hereby incorporated by reference herein in their entirety.

### BACKGROUND

### Field of the Technology

The present disclosure relates to a technique of connection processing of a communication apparatus to a wireless network.

### Description of the Related Art

Electronic apparatuses having a wireless communication function such as a digital camera, a printer, a portable phone, and a smartphone have increased. For example, such electronic apparatus can establish a connection in various forms such as direct connection between electronic apparatuses and connection via an access point, a base station, or the like, and perform communication.

To perform wireless connection of an electronic apparatus, it is necessary to set connection parameters such as an encryption method, an encryption key, an authentication method, and an authentication key. Japanese Patent Laid-Open No. 2006-261938 describes a technique in which an access point encodes connection parameters into a QR Code® and displays it on a screen, and an electronic apparatus captures the screen to decode the QR code and then sets the connection parameters. Furthermore, US-2014-0269646 describes a method of including the capability information and role information of an electronic apparatus in a QR code.

Since wireless connection can be established in various forms as described above, the electronic apparatus can be connected to the same partner apparatus in various forms. On the other hand, it is necessary to set connection parameters for each form. Therefore, if unnecessary connection is established, unnecessary connection parameters may be set. Thus, from the viewpoint of an efficient operation of a network, it is important to prevent unnecessary connection from being established.

### SUMMARY

The present disclosure provides efficient connection control of a communication apparatus to a network.

According to one aspect of the present disclosure, there is provided a one or more processors; and one or more memories that store a computer-readable instruction for causing, when executed by the one or more processors, the one or more processors to perform a control method comprising: providing, to another apparatus, setting information including a connection parameter to be used to establish a connection to a first network for enabling the other apparatus to communicate with the communication apparatus, and identification information for specifying a service provided by the communication apparatus, to be used by a service detection method after the establishment of the connection.

Features of the present disclosure will become apparent from the following description of embodiments with reference to the attached drawings.

### BRIEF DESCRIPTION OF THE DRAWINGS

FIG. 1 is a view showing an example of the configuration of a wireless communication system;

FIG. 2 is a block diagram showing an example of the configuration of a printer;

FIG. 3 is a block diagram showing an example of the configuration of a smartphone;

FIG. 4 is a flowchart illustrating an example of the procedure of processing executed by the printer;

FIG. 5 is a view showing an example of a screen for displaying setting information;

FIG. 6 is a flowchart illustrating an example of the procedure of processing executed by the smartphone;

FIG. 7 is a table showing an example of information managed by the smartphone;

FIG. 8 is a sequence chart showing an example of the procedure of processing in a case where the printer is in an online state;

FIG. 9 is a sequence chart showing an example of the procedure of processing in a case where the printer is in an offline state; and

FIG. 10 is a view showing an example of the structure of the setting information.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### (System Configuration)

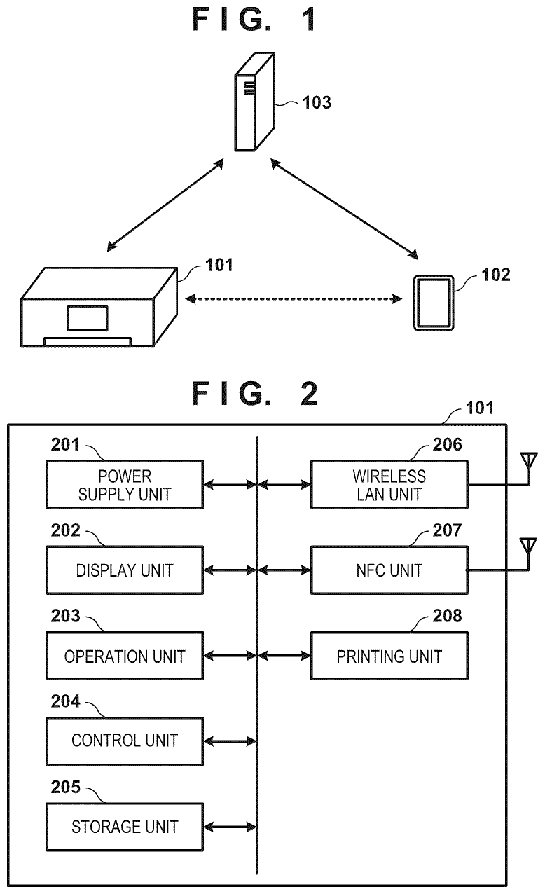

FIG. 1 shows an example of the configuration of a wireless communication system according to this embodiment. The wireless communication system includes a plurality of communication apparatuses. FIG. 1 shows a state in which a printer 101, a smartphone 102, and an access point 103 can wirelessly be connected to each other using a wireless local area network (wireless LAN). Note that the printer 101 and the smartphone 102 can establish a connection via the access point 103, and can also establish a connection using the direct communication function of the wireless LAN without intervention of the access point 103. In addition, for example, the printer 101 and the smartphone 102 can communicate with each other using a short distance wireless communication technique such as Near Field Communication (NFC). Note that FIG. 1 shows only a small number of communication apparatuses for the descriptive convenience, but a large number of communication apparatuses can exist without losing generality.

To enable communication between communication apparatuses, it is necessary to connect these communication apparatuses to a wireless network. On the other hand, to connect the communication apparatuses to the wireless network, time, power, and the like are required to perform processing necessary for connection, such as connection parameter setting and role decision. Thus, unnecessary connection to the wireless network may deteriorate the operation efficiency of the wireless communication system. For example, when the printer 101 prints data held by the smartphone 102, the smartphone 102 and the printer 101 can execute the printing by, for example, being connected to the wireless network via the access point 103. On the other hand, even in a case where the connection is established, the smartphone 102 and the printer 101 can establish a connection in an additional wireless network using Wi-Fi Direct® or the like. However, in this case, although it suffices to use the connection established via the access point 103, processing for connection to a new wireless network occurs, and efficiency is assumed to be low. On the other hand, there is a status in which connection can selectively be performed to an appropriate network depending on various conditions such as the communication rate of the wireless network and the security level. In this embodiment, there is provided a method of implementing at least one of improvement of the operation efficiency of the wireless communication system and enabling of selection of an appropriate network.

### (Apparatus Configuration)

FIG. 2 shows an example of the configuration of the printer 101. The printer 101 includes, for example, a power supply unit 201, a display unit 202, an operation unit 203, a control unit 204, a storage unit 205, a wireless LAN unit 206, an NFC unit 207, and a printing unit 208. Note that this configuration is merely an example, and some of these function units may be omitted or replaced by other function units, or other function units may be added.

The power supply unit 201 includes, for example, a battery or a circuit configured to receive supply of power from an AC power supply. For example, the power supply unit 201 supplies power supplied from the AC power supply or power accumulated in the battery to each unit of the printer 101. The display unit 202 includes, for example, a light emitting diode (LED) or a liquid crystal display (LCD). For example, the display unit 202 presents information to the user by performing screen display using the LCD or an illumination pattern by the LED. The operation unit 203 includes, for example, buttons, and accepts various operations from the user. Note that the display unit 202 and the operation unit 203 may be formed by one module like a touch panel display. The control unit 204 includes, for example, one or more processors such as a central processing unit (CPU) and a micro processor unit (MPU). The storage unit 205 is formed by, for example, one or more memories such as a read only memory (ROM) and a random access memory (RAM). For example, the storage unit 205 stores programs for performing various processes to be described later, and various kinds of information. Furthermore, the control unit 204 controls the overall printer 101 by executing a program stored in the storage unit 205 and executes various processes to be described later.

The wireless LAN unit 206 executes various communication control operations and transmission/reception of wireless LAN radio waves complying with the IEEE 802.11 standard and the Wi-Fi standard. Note that IEEE is an acronym for Institute of Electrical and Electronics Engineers. The wireless LAN unit 206 includes a wireless LAN module and an antenna. The wireless LAN unit 206 serves as a terminal station in the infrastructure mode of the IEEE 802.11 standard, and can be connected to another terminal station via the access point and communicate with it. The wireless LAN unit 206 can also directly be connected to another wireless LAN terminal station using Wi-Fi Direct without intervention of the access point and communicate with it. For example, the NFC unit 207 executes various communication control operations and transmission/reception of radio waves for short distance wireless communication complying with the NFC standard such as ISO/IEC 14443, ISO/IEC 15693, or ISO/IEC 18092. Note that ISO is an abbreviation for International Organization for Standardization, and IEC is an abbreviation for International Electrotechnical Commission. The NFC unit 207 includes, for example, an NFC module and an antenna. For example, the printing unit 208 prints an image, characters, and the like on a print medium such as a sheet. The printing unit 208 includes, for example, a printer head, a driving device for it, and an ink tank.

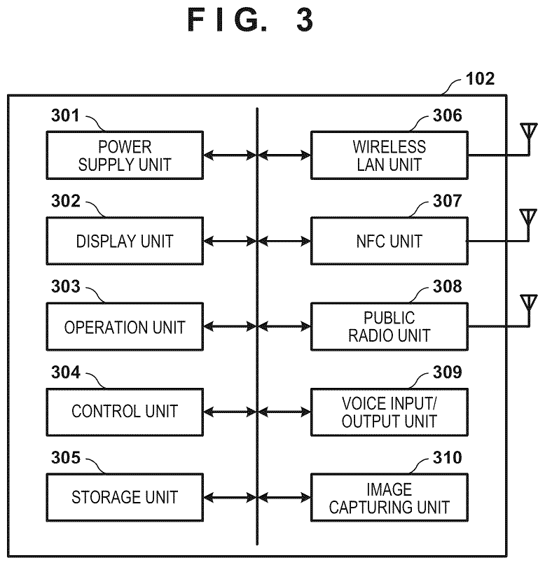

FIG. 3 shows an example of the configuration of the smartphone 102. The smartphone 102 includes, for example, a power supply unit 301, a display unit 302, an operation unit 303, a control unit 304, a storage unit 305, a wireless LAN unit 306, an NFC unit 307, a public radio unit 308, a voice input/output unit 309, and an image capturing unit 310. Note that this configuration is merely an example, and some of these function units may be omitted or replaced by other function units, or other function units may be added.

The power supply unit 301 includes, for example, a battery. For example, the power supply unit 301 supplies power accumulated in the battery to each unit of the smartphone 102. The display unit 302 includes, for example, an LED or an LCD. For example, the display unit 302 presents information to the user by performing screen display using the LCD or an illumination pattern by the LED. The operation unit 303 includes, for example, buttons, and accepts various operations from the user. Note that the display unit 302 and the operation unit 303 may be formed by one module like a touch panel display. The control unit 304 includes, for example, one or more processors such as a CPU and an MPU. The storage unit 305 is formed by, for example, one or more memories such as a ROM and a RAM. For example, the storage unit 305 stores programs for performing various processes to be described later, and various kinds of information. Furthermore, the control unit 304 controls the overall smartphone 102 by executing a program stored in the storage unit 305 and executes various processes to be described later.

The wireless LAN unit 306 includes a wireless LAN module and an antenna, and executes various communication control operations and transmission/reception of wireless LAN radio waves complying with the IEEE 802.11 standard and the Wi-Fi standard. The wireless LAN unit 306 serves as a terminal station in the infrastructure mode of the IEEE 802.11 standard, and can be connected to another terminal station via the access point and communicate with it. The wireless LAN unit 306 can also directly be connected to another wireless LAN terminal station using Wi-Fi Direct without intervention of the access point and communicate with it. The NFC unit 307 includes, for example, an NFC module and an antenna, and executes various communication control operations and transmission/reception of radio waves for short distance wireless communication complying with the NFC standard. The public radio unit 308 includes, for example, a module and an antenna for communication complying with the 3rd Generation Partnership Project (3GPPR) Long Term Evolution (LTE) standard or the 5th Generation (5G) standard. The public radio unit 308 executes various communication control operations and transmission/reception of radio waves for communication complying with the LET or 5G standard.

The voice input/output unit 309 includes a microphone and a loudspeaker, and performs, for example, voice input for performing an operation by speech communication or a voice, and voice output for speech communication, notification, or the like. The image capturing unit 310 includes an image sensor and a lens, and captures a still image and a moving image.

### (Procedure of Processing)

Subsequently, an example of the procedure of processing executed by each of the printer 101 and the smartphone 102 will be described.

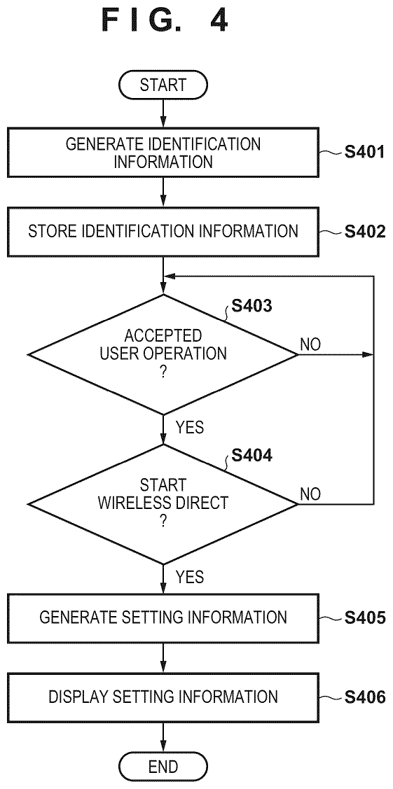

FIG. 4 shows an example of the procedure of processing executed by the printer 101. This processing can be started when, for example, the printer 101 is activated. Note that the printer 101 can be connected to the Internet or the like via, for example, the access point 103.

When the processing is started, the printer 101 generates identification information concerning a providable service (step S401), and stores the generated identification information (step S402). This identification information is, for example, identification information for uniquely identifying the printer 101, and information to be used for service detection. This identification information is, for example, a UUID to be used for service detection such as DNS-SD defined in RFC6763. Note that RFC is an acronym for Request for Comments, DNS-SD is an acronym for DNS-Based Service Discovery, and UUID is an acronym for Universally Unique Identifier. In addition, DNS is an acronym for Domain Name System. The printer 101 generates, for example, a UUID corresponding to a print service. Furthermore, for example, the printer 101 performs initialization processing so as to be able to respond to service detection such as DNS-SD, and then responds in a case where, for example, a service inquiry (query) is received via the network. A response to service detection can be sent (not shown) simultaneously with the processing shown in FIG. 4. Note that service detection is a known technique and a description thereof will be omitted.

The printer 101 waits for acceptance of a user operation after generation and storage of the identification information (step S403). If a user operation is detected by the operation unit 203 (YES in step S403), the printer 101 determines whether the user operation is a wireless direct start instruction (step S404). Note that wireless direct indicates, for example, a connection establishment method using Wi-Fi Direct. Note that wireless direct may indicate a method of establishing direct connection by another method instead of Wi-Fi Direct. If a wireless direct start instruction is accepted (YES in step S404), the printer 101 starts, for example, an operation as a Wi-Fi Direct base station, and generates a wireless network. In this case, the printer 101 generates setting information using connection parameters to be set in both the printer 101 and the partner apparatus (for example, the smartphone 102), and the identification information stored in step S402 (step S405). Note that the connection parameters may be preset, or generated when the wireless direct start instruction is accepted. To provide the generated setting information to the smartphone 102, the printer 101 displays the setting information on the screen using the display unit 202 (step S406). By displaying the setting information, the printer 101 can accept both infrastructure connection for communication via the access point 103 and direct connection for communication without intervention of the access point 103.

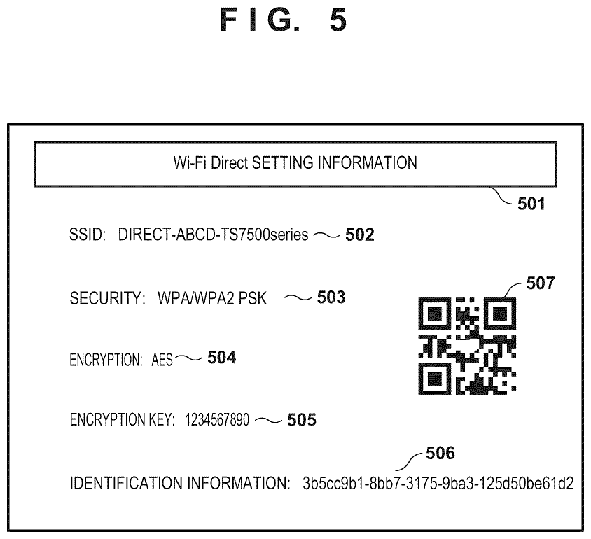

The setting information displayed by the printer 101 will now be described with reference to FIG. 5. Information 501 is information indicating that the setting information displayed on the screen is setting information concerning Wi-Fi Direct. In the example shown in FIG. 5, as items of the setting information, a Service Set Identifier (SSID) 502, a security method 503, an encryption method 504, and an encryption key 505 are displayed. Note that these connection parameters need not always be displayed, and only some of them may be displayed. For example, other information such as other identification information including information indicating the printer 101 instead of the SSID may be displayed. In this embodiment, as described above, in addition to the connection parameters, setting information including identification information 506 generated in step S401 and stored in step S402 is displayed. In the example shown in FIG. 5, to provide the setting information from the printer 101 to the smartphone 102, an image 507 obtained by encoding information including the connection parameters and the identification information 506 is displayed. Note that in an example, the image 507 is a QR Code®.

Normally, when a communication apparatus can perform communication after establishment of connection to a partner apparatus, the communication apparatus obtains a UUID from the partner apparatus by communicating with the partner apparatus using the service detection method such as DNS-SD. In contrast, in this embodiment, the partner apparatus (printer 101) generates an image (QR code) that can be used to specify the UUID, and presents it. Note that the UUID can be prepared for each provided service. The communication apparatus (smartphone 102) obtains the image by capturing it, thereby obtaining the UUID. That is, the smartphone 102 obtains the UUID concerning the service provided by the printer 101 before the smartphone 102 is connected to the printer 101 in a communication-enabling manner. Then, the communication apparatus can specify, based on the UUID, service information that can be provided by the partner apparatus. For example, the smartphone 102 can detect, based on the UUID obtained from the printer 101, that the printer 101 provides a service such as a print service or a scan service. This can shorten a service search time in the communication apparatus. Note that this embodiment will describe a case where a UUID is used as identification information for identifying a service or an application, but other identification information having a similar function may be used.

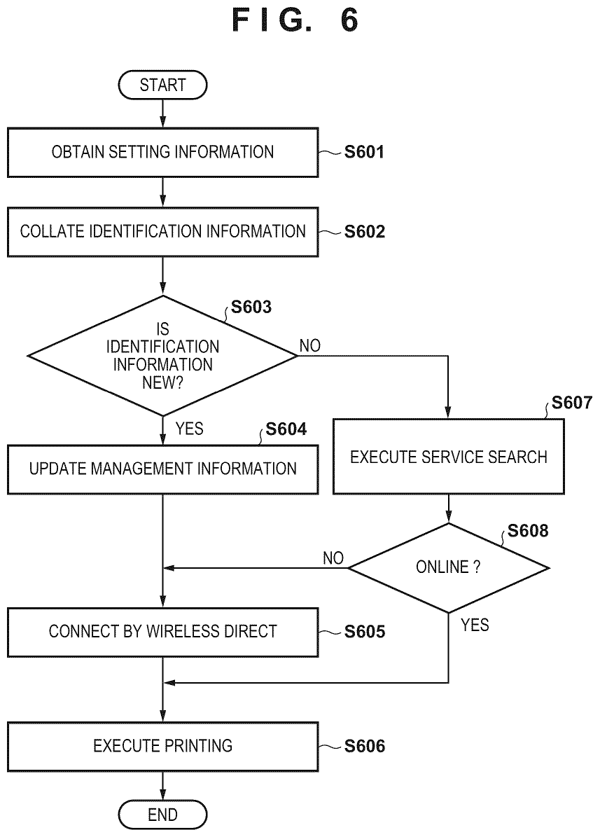

Subsequently, an example of the procedure of processing executed by the smartphone 102 will be described with reference to FIG. 6. The smartphone 102 starts the processing when, for example, a user operation of instructing to perform connection using Wi-Fi Direct in order to execute printing is accepted via the operation unit 303. Note that the smartphone 102 can be connected to the Internet or the like via, for example, the access point 103.

When the processing is started, the smartphone 102 activates the image capturing unit 310. Then, when the user captures the QR code (image 507) displayed by the printer 101, the smartphone 102 obtains the setting information including the above-described connection parameters and identification information for specifying the service information (step S601). This allows the smartphone 102 to obtain, for example, the connection parameters including the SSID 502, the security method 503, the encryption method 504, and the encryption key 505, and the identification information 506 of the printer 101. Note that the smartphone 102 can store the obtained information as management information, and manage it.

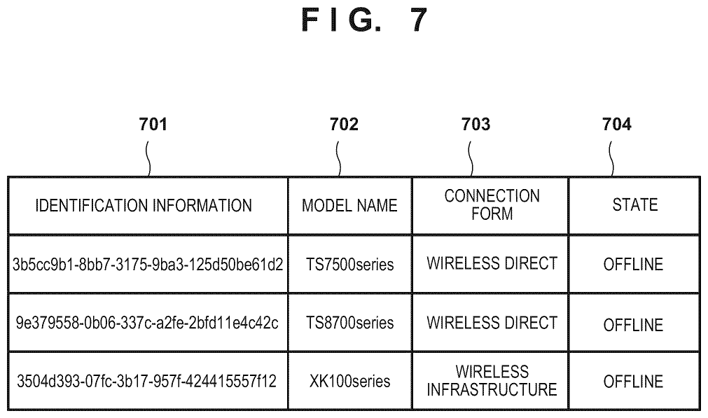

The structure of the management information managed by the smartphone 102 will now be described with reference to FIG. 7. The smartphone 102 stores and manages, as management information, various kinds of information for each piece of identification information of the printer obtained by service detection such as DNS-SD or obtained from the Wi-Fi Direct setting information. As an example, the management information is used for wireless network connection control for printing. Note that information about a service other than printing can be managed, as a matter of course. In the management information, identification information 701 is the identification information (UUID) of the printer obtained by service detection such as DNS-SD or obtained from the Wi-Fi Direct setting information. A model name 702 is the model name of the printer obtained by service detection. A connection form 703 indicates the type of the wireless network when the smartphone 102 is connected to each printer. For example, the connection form 703 indicates which of Wi-Fi Direct (wireless direct) and the infrastructure mode (wireless infrastructure) can be used to perform connection to each printer. A state 704 indicates whether the printer is in the online state or the offline state. Note that the online state can indicate, for example, whether connection to the Internet or the like via the access point 103 can be performed or not and whether service detection by DNS-SD can be performed or not. That is, the state in which service detection by DNS-SD can be performed can be the online state, and the state in which service detection by DNS-SD cannot be performed can be the offline state. When new identification information is obtained from the Wi-Fi Direct setting information, the smartphone 102 can set, to the offline state, the state 704 corresponding to the identification information. Then, when the identification information is also detected by DNS-SD, the smartphone 102 may update the state 704 to the online state.

The smartphone 102 compares the identification information 506 of the printer 101 included in the setting information obtained in step S601 with the identification information 701 of the management information, and collates whether information concerning the identification information 506 is stored as the management information (step S602). Then, if the information corresponding to the obtained identification information 506 is not included in the management information, the smartphone 102 determines that the identification information is new information (YES in step S603). In this case, the smartphone 102 registers the information corresponding to the identification information 506 in the management information (step S604). For example, the smartphone 102 registers the obtained identification information 506 as the identification information 701, and registers, as the model name 702, the model name of the printer 101 obtained based on the identification information 506. Furthermore, since the identification information 506 is included in the setting information obtained for Wi-Fi Direct connection, the connection form 703 is set to wireless direct. Note that the smartphone 102 need not register particular information as the state 704. After that, the smartphone 102 sets the connection parameters of the SSID 502, the security method 503, the encryption method 504, and the encryption key 505 included in the obtained setting information, and performs wireless direct connection to the printer 101 (step S605). Then, the smartphone 102 executes printing using the established connection (step S606).

On the other hand, if it is determined that the identification information 506 is not new information (NO in step S603), the smartphone 102 executes service detection using DNS-SD or the like before performing wireless direct connection (step S607). Then, the smartphone 102 determines whether the printer matching the identification information 506 obtained by service detection in step S601 has responded. That is, with this determination processing, the smartphone 102 confirms, for example, whether the printer 101 is connected to the access point 103 (in the online state) (step S608). If the printer 101 is in the offline state (NO in step S608), the smartphone 102 establishes connection to the printer 101 using Wi-Fi Direct (step S605), and executes printing (step S606). On the other hand, if the printer 101 is in the online state (YES in step S608), the smartphone 102 executes printing without establishing connection using Wi-Fi Direct (step S606). That is, if the printer 101 is in the online state, the smartphone 102 can determine that it can communicate with the printer 101 via the access point 103. Thus, since the smartphone 102 can execute printing by communication via the access point 103, new connection is not established. Therefore, since the smartphone 102 does not establish a connection to the wireless network that need not be connected, the operation efficiency of the wireless communication system is improved.

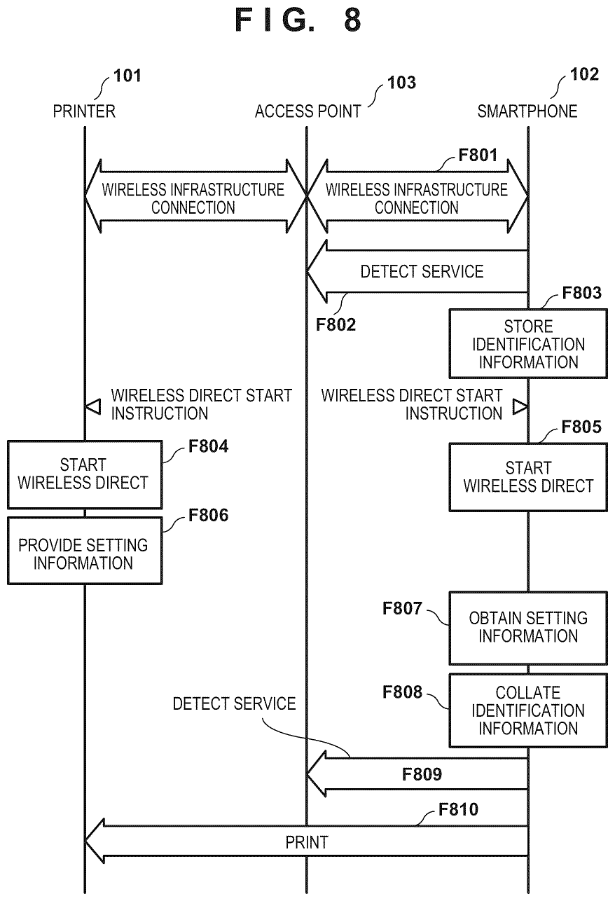

FIG. 8 shows an example of the procedure of communication in the wireless communication system in a case where the printer 101 is in the online state (that is, a state in which the printer 101 is connected to the wireless network via, for example, the access point 103). First, each of the printer 101 and the smartphone 102 is connected to the wireless network via the access point 103 in response to, for example, acceptance of a predetermined user operation (F801). Note that when the printer 101 is connected to the wireless network via the access point 103, the printer 101 transitions to the online state. When the smartphone 102 is connected to the wireless network via the access point 103, the smartphone 102 can detect a service provided by another communication apparatus connected to the wireless network. In this example, assume that the smartphone 102 performs service detection for executing printing (F802). Then, the smartphone 102 stores, as management information, identification information obtained by service detection (F803). In this case, with respect to the detected information, the state 704 in the management information is set to “online”. Note that service detection and storage of the management information may be performed for, for example, every predetermined period. Then, based on the obtained identification information, the smartphone 102 can register information concerning the newly detected identification information or update information concerning the already registered identification information. For example, if the identification information detected in the past is not detected, the state 704 concerning the identification information is updated to “offline”. If the identification information set with the offline state is detected again, the state 704 can be updated to “online”. Service detection and storage of management information may be performed only once when, for example, the smartphone 102 is connected to the access point 103 or a predetermined user operation is performed.

After that, assume that the user operates the printer 101 and the smartphone 102 to perform Wi-Fi Direct connection for executing printing. Upon accepting this user operation, each of the printer 101 and the smartphone 102 starts wireless direct processing (F804 and F805). When this processing is started, the printer 101 provides the setting information by, for example, displaying the screen indicating the setting information, as shown in FIG. 5 (F806). Then, the smartphone 102 obtains the setting information by, for example, capturing the QR code shown in FIG. 5 (F807). Upon obtaining the setting information, the smartphone 102 executes collation processing for confirming whether the identification information concerning the service of the printer 101 included in the setting information matches the identification information 701 in the information stored as the management information (F808). In this case, the smartphone 102 determines that the identification information detected in F802 matches the identification information obtained in F807. In this case, the smartphone 102 re-executes service detection, and confirms whether a response including the identification information obtained in F807 is received (F809). With this confirmation processing, it is determined whether the printer 101 is in the online state (a state in which the printer 101 can communicate with the smartphone 102 via the access point 103). Note that in a case where the processing of F802 is performed for every predetermined period and it can be recognized whether the printer 101 is in the online state, the confirmation processing of F809 need not be performed. Upon confirming that the printer 101 is in the online state, the smartphone 102 can specify that it can communicate with the printer 101 without establishing wireless direct connection. Therefore, in this case, the smartphone 102 executes communication for printing with the printer 101 without establishing wireless direct connection (F810).

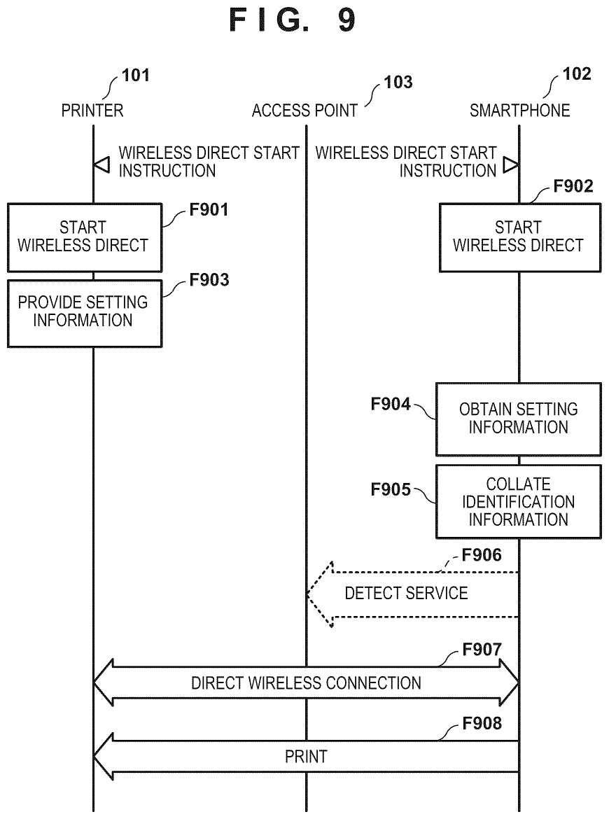

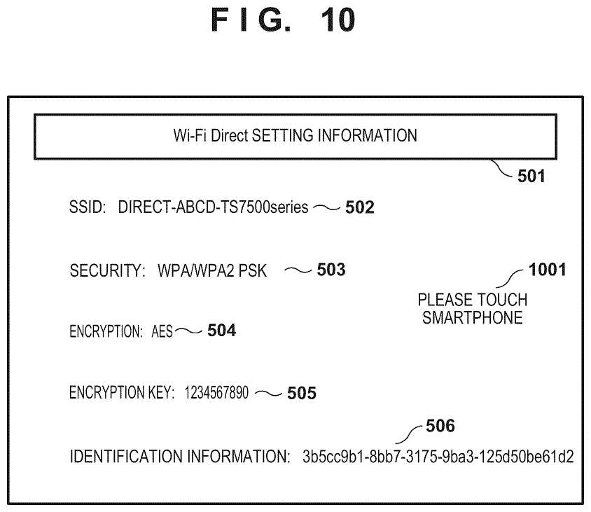

Subsequently, an example of the procedure of communication in the wireless communication system in a case where the printer 101 is in the offline state will be described with reference to FIG. 9. This processing example assumes that the printer 101 and the smartphone 102 are not connected to the wireless network via the access point 103. Note that for example, only the smartphone 102 may be connected to the wireless network via the access point 103. In this case, the smartphone 102 can execute service detection processing in response to establishment of the connection. However, in this case, since the printer 101 is not connected to the wireless network, the smartphone 102 does not obtain the management information concerning the identification information provided by the printer 101. Note that the smartphone 102 can be assumed to hold the management information when it was connected to the printer 101 in the past. However, in this case as well, when the smartphone 102 executes service detection processing via the access point 103, the smartphone 102 does not obtain the identification information of the printer 101, and thus recognizes that the printer 101 is in the offline state.

Referring to FIG. 9, assume that the user operates the printer 101 and the smartphone 102 to perform Wi-Fi Direct connection for executing printing. By accepting the user operation, each of the printer 101 and the smartphone 102 starts wireless direct processing (F901 and F902). When this processing is started, the printer 101 provides the setting information by, for example, displaying the screen indicating the setting information, as shown in FIG. 5 (F903). Then, the smartphone 102 obtains the setting information by, for example, capturing the QR code shown in FIG. 5 (F904). Upon obtaining the setting information, the smartphone 102 executes collation processing for confirming whether the identification information concerning the service of the printer 101 included in the setting information matches the identification information 701 in the information stored as the management information (F905). If the smartphone 102 has not obtained the identification information of the printer 101 via the access point 103, the smartphone 102 newly registers and stores, as management information, information concerning the identification information. On the other hand, if the printer 101 was in the online state in the past or the smartphone 102 has established wireless direct connection to the printer 101 before, the management information includes the identification information matching the identification information obtained in F904. In this case, the smartphone 102 executes service detection processing via the access point 103 (F906). However, in this case, since the printer 101 is not connected to the wireless network via the access point 103, the printer 101 does not respond to the inquiry from the smartphone 102. Therefore, the smartphone 102 determines that the printer 101 is in the offline state, and establishes wireless direct connection (F907), and then executes communication for printing with the printer 101 (F908).

As described above, the smartphone 102 obtains the information of the printer 101 by capturing the image displayed by the printer 101 for wireless direct connection. If the smartphone 102 can execute communication with the printer 101 via the access point 103, the smartphone 102 does not execute processing that requires communication for wireless direct connection. That is, in this case, the smartphone 102 only obtains the information by capturing the image, and then ends the wireless direct processing. That is, the smartphone 102 does not execute unnecessary connection processing to the network. This makes it possible to efficiently perform connection and communication between the printer 101 and the smartphone 102.

Note that in the above-described example, a case where the smartphone 102 obtains the setting information by capturing the QR code has been explained, but the present disclosure is not limited to this. For example, the printer 101 and the smartphone 102 may transmit/receive the setting information using NFC or the like. In this case, the printer 101 can display, for example, a screen shown in FIG. 10 based on acceptance of a user operation of instructing to execute wireless direct processing. As compared with the screen shown in FIG. 5, the screen shown in FIG. 10 does not display the QR code (the image 507), and instead displays information 1001 for allowing the user to understand that the setting information is provided using NFC. Other information is the same as in FIG. 5. When the user brings the smartphone 102 into contact with the printer 101, communication using the NFC unit 207 and the NFC unit 307 is executed. Then, the setting information including the connection parameters and the identification information corresponding to the service is transmitted from the printer 101 to the smartphone 102. This can obtain the same effect as in the above-described embodiment. Note that which of the method using the QR code and the method of using short distance wireless communication such as NFC is used may be decided by a user operation. That is, the printer 101 may display a screen for selecting which of the methods should be used to provide the setting information, and accept user selection of the method. Note that short distance wireless communication may be performed using, for example, a method such as Bluetooth® Low Energy other than NFC.

Note that an example in which if the smartphone 102 determines by service detection that the printer 101 is in the online state, wireless direct connection processing is not performed has been described above. However, this is merely an example, and for example, if it is determined by service detection that the printer 101 is in the online state, whether to execute wireless direct connection processing may be decided based on a predetermined criterion such as a communication rate or reliability. For example, the smartphone 102 can hold a condition concerning the communication rate or reliability in accordance with the type of communication and the type of an application that requests communication. For example, in a case where the communication rate via the access point 103 is lower than a predetermined rate, or a case where the reliability level (for example, radio quality) is lower than a predetermined level, the smartphone 102 can establish wireless direct connection. Alternatively, in a case where a communication delay via the access point 103 exceeds a predetermined value, the smartphone 102 may decide to establish wireless direct connection. Alternatively, for example, the smartphone 102 may estimate the communication rate or the reliability level based on the strength of a radio signal transmitted from the printer 101, and compare the estimated value with the communication rate or the reliability level obtained by communication via the access point 103. In this case, if the estimated value of the communication rate estimated concerning wireless direct connection exceeds a result of adding a predetermined offset value to the communication rate obtained by communication via the access point 103, wireless direct connection may be established. If the estimated value of the reliability level estimated concerning wireless direct connection exceeds a result of adding a predetermined offset value to the reliability level obtained by communication via the access point 103, wireless direct connection may be established. That is, if benefit from establishment of wireless direct connection is large, the connection may be established.

If it is determined by service detection that the printer 101 is in the online state, the user may be inquired about whether to establish wireless direct connection. If a user operation of instructing to establish wireless direct connection is accepted, wireless direct connection may be established.

According to this, in a case where the printer 101 is in the online state, it is possible to selectively establish wireless direct connection in accordance with a user request or communication performed by the smartphone 102.

Alternatively, in a case where the printer 101 is connected to the wireless network via the access point 103, the setting information need not include the identification information. In a case where the setting information includes no identification information, the smartphone 102 can decide not to establish wireless direct connection. In this case, if the printer 101 accepts only printing via the access point 103, no identification information is included in the setting information; otherwise, the identification information may be included in the setting information. For example, for a temporary service, temporarily effective identification information may be prepared. In this case, the printer 101 can discriminately handle a print service via the access point 103 and a print service using wireless direct connection. For example, the printer 101 may temporarily stop the print service via the access point 103. If the service via wireless direct connection cannot be provided or is stopped, the printer 101 need not include the identification information in the setting information.

Note that an example in which it is determined whether the printer 101 and the smartphone 102 can be connected to each other via the access point 103 has been described above, but the present disclosure is not limited to this. That is, it suffices to determine whether the printer 101 and the smartphone 102 can communicate with each other via connection other than wireless direct connection. Therefore, even if the printer 101 is connected to a predetermined LAN by wired connection and the smartphone 102 is connected to the predetermined LAN via the access point 103, it can also be determined that the printer 101 is in the online state.

An example of the procedure of processing of deciding, based on whether the printer 101 can perform communication via the access point 103, whether the smartphone 102 is connected to the printer 101 by wireless direct connection has been described above, but the present disclosure is not limited to this. That is, it is not that only when the smartphone 102 is directly connected to the printer 101, the above-described method is applicable. For example, the printer 101 may provide, to the smartphone 102, the setting information including the connection parameters for connection to the access point 103 and the identification information of the service of the self-apparatus. For example, in a case where the printer 101 is connected to the network by wired connection, and the smartphone 102 can be connected to the network using a wireless medium other than the wireless LAN, it is unnecessary to establish a connection via the access point 103. That is, the method according to this embodiment can be more generalized. For example, it can be determined whether the communication apparatus can obtain, from the partner apparatus, the identification information corresponding to the service together with the connection parameters for connection to the first network, and obtain the identification information via the second network different from the first network. Then, if the communication apparatus cannot obtain the identification information via the second network, it can execute connection processing to the first network using the obtained connection parameters. Note that in a case where the communication apparatus can obtain the identification information via the second network, it may decide not to perform connection to the first network, or decide, based on a predetermined criterion such as a communication rate or reliability, whether to perform connection to the first network. Note that the partner apparatus provides the setting information including the connection parameters for connection to the first network and the identification information of the service provided by the communication apparatus. Furthermore, if the partner apparatus receives an inquiry via the second network different from the first network, it transmits the above-described identification information via the second network. Note that if the partner apparatus is not connected to the second network, it does not receive an inquiry via the second network, as a matter of course, and thus does not transmit the identification information via the second network. Then, if the partner apparatus does not transmit the identification information to the communication apparatus via the second network, it communicates with the communication apparatus via the first network. Alternatively, if the partner apparatus transmits the identification information to the communication apparatus via the second network, it can communicate with the communication apparatus via one of the first network and the second network in accordance with decision of whether the communication apparatus is connected to the partner apparatus via the first network. In this way, it is possible to perform an operation so as to enable efficient network connection between the communication apparatus and the partner apparatus.

According to the present disclosure, it is possible to provide efficient connection control of a communication apparatus to a network.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus comprising:
one or more processors; and
one or more memories that store a computer-readable instruction for causing, when executed by the one or more processors, the one or more processors to perform a control method comprising:
providing, to another apparatus, setting information including a connection parameter to be used to establish a connection to a first network for enabling the other apparatus to communicate with the communication apparatus, and identification information for specifying a service provided by the communication apparatus, to be used by a service detection method after the establishment of the connection.

2. The communication apparatus according to claim 1, wherein
the first network is a network to which the communication apparatus and the other apparatus are directly connected.

3. The communication apparatus according to claim 1, wherein the control method further comprises accepting a user operation for enabling the communication apparatus and the other apparatus to communicate with each other via the first network, and
wherein the communication apparatus provides the setting information to the other apparatus in response to acceptance of the user operation in the communication apparatus and the other apparatus.

4. The communication apparatus according to claim 1, wherein the control method further comprises displaying a QR code obtained by encoding the setting information.

5. The communication apparatus according to claim 1, wherein the control method further comprises transmitting the setting information to the other apparatus using short distance wireless communication.

6. The communication apparatus according to claim 1, wherein the identification information is a Universally Unique Identifier (UUID) used in Domain Name System-Based Service Discovery (DNS-SD).

7. The communication apparatus according to claim 1, wherein the control method further comprises
transmitting the identification information via a second network different from the first network in a case where an inquiry is received via the second network, and
communicating with the other apparatus via the first network in a case where the inquiry is not received from the other apparatus via the second network.

8. The communication apparatus according to claim 7, wherein in a case where the inquiry is received from the other apparatus via the second network and the identification information is transmitted to the other apparatus via the second network, connection of the other apparatus to the first network is not established, and the communication apparatus communicates with the other apparatus via the second network.

9. The communication apparatus according to claim 7, wherein in a case where the communication apparatus receives the inquiry from the other apparatus via the second network, and the identification information is transmitted to the other apparatus via the second network, the communication apparatus communicates with the other apparatus via one of the first network and the second network, which is selected by the other apparatus.

10. A control method executed by a communication apparatus, comprising:
providing, to another apparatus, setting information including a connection parameter to be used to establish a connection to a first network for enabling the other apparatus to communicate with the communication apparatus, and identification information for specifying a service provided by the communication apparatus, to be used by a service detection method after the establishment of the connection.

11. A non-transitory computer-readable storage medium that stores a program for causing a computer included in a communication apparatus to perform a control method comprising:
providing, to another apparatus, setting information including a connection parameter to be used to establish a connection to a first network for enabling the other apparatus to communicate with the communication apparatus, and identification information for specifying a service provided by the communication apparatus, to be used by a service detection method after the establishment of the connection.
